(19) United States
(12) Patent Application Publication
(10) Pub. No.: US 2022/0326043 A1
(43) Pub. Date: Oct. 13, 2022

(54) METHODS AND SYSTEMS FOR GENERATING AND DISPLAYING A TARGET ALTITUDE AND A TARGET SPEED OF A VEHICLE

(71) Applicant: Honeywell International Inc., Charlotte, NC (US)

(72) Inventors: John SUDDRETH, Charlotte, NC (US); Jerry Ball, Charlotte, NC (US)

(73) Assignee: Honeywell International Inc.

(21) Appl. No.: 17/225,888

(22) Filed: Apr. 8, 2021

(51) Int. Cl. G01C 23/00; G06F 3/14; G06T 11/20; G08G 5/00; B64D 43/02

(52) U.S. Cl. CPC G01C 23/005; G06F 3/14; G06T 11/206; G08G 5/0021; G08G 5/0047; B64D 43/02

(57) ABSTRACT

Disclosed are methods, systems, and a non-transitory computer-readable medium for generating and displaying a target altitude and a target speed for a vehicle to ensure sonic boom values remain within permissible threshold values. For instance, the method may include receiving speed data, altitude data, and flight path data for a flight path of the vehicle, and generating at least one of a target altitude and a target speed for each of one or more locations along the flight path based on the received speed data, altitude data, and flight path data, and a permissible threshold boom value for each of the one or more locations. The method may also include outputting the generated at least one of the target altitude and the target speed to a display system.

### TECHNICAL FIELD

Various embodiments of the present disclosure relate generally to methods and systems for generating and displaying a target altitude and a target speed for a supersonic flight of a vehicle.

### BACKGROUND

Supersonic vehicles, for example, supersonic aircraft, generate a sonic boom when traveling faster than the speed of sound. Factors that influence a strength of a sonic boom include the weight, size, and shape of the vehicle, in addition to the altitude, speed, and flight path of the vehicle, as well as weather and atmospheric conditions. For example, the higher the altitude of the vehicle, the greater the distance the shock waves must travel to reach the ground, which, in turn, reduces an intensity of the sonic boom. The sonic boom forms a boom “carpet” on the ground having a maximum intensity directly beneath the vehicle, and decreasing as a lateral distance from the flight path increases. Lateral spread of the sonic boom depends upon the altitude and speed of the aircraft, as well as the atmosphere. Maneuvers, such as pushovers, acceleration, or “S” turns, of the vehicle may amplify the intensity of the sonic boom. In addition, geographic features of the ground, such as hills, valleys, and mountains, can reflect shock waves of the sonic boom, which may increase the intensity of the sonic boom.

The shock waves from the sonic booms can cause damage, such as compromised structural stability and shattered glass, to structures that lie within the boom carpet, and generate noise disturbances in areas within the boom carpet. Therefore, certification authorities, such as the United States Federal Aviation Administration (FAA), prohibit or restrict operation of a civil aircraft at a true flight Mach number greater than 1 over land in the United States, and from a certain distance off shore when a sonic boom could reach U.S. shores. As the FAA considers a range of permissible supersonic operations, however, there is a need to consider how to account for restrictions relating to permissible sonic boom values during operation of the vehicle.

For example, systems and/or operators of supersonic vehicles may need to adjust flight plans to accommodate restrictions, such as minimum, or floor, requirements that dictate a minimum altitude that a vehicle may cruise at supersonic speed, or maximum Mach speed requirements (based on altitude) for a geographic region through which the vehicle is to travel. More specifically, altitudes, speeds, and timings and locations for maneuvers, such as climbs, descents, accelerations, or decelerations, may require adjustment to minimize sonic booms generated by these maneuvers. There is a need to quickly and efficiently determine altitudes and/or speeds that comply with such restrictions pertaining to sonic booms, as well as the corresponding times and locations along a planned flight path for performing maneuvers, and to quickly and efficiently provide this information to an operator of the vehicle.

The present disclosure is directed to addressing one or more of these above-referenced needs.

### SUMMARY OF THE DISCLOSURE

According to certain aspects of the disclosure, methods and systems are disclosed for generating and displaying at least one of a target altitude and a target speed to an operator of a vehicle during supersonic flight of the vehicle.

For instance, a method of generating and displaying at least one of a target altitude and a target speed to an operator of a vehicle may include receiving speed data, altitude data, and flight path data for a flight path of the vehicle, and generating at least one of a target altitude and a target speed for each of one or more locations along the flight path based on the received speed data, altitude data, and flight path data and a permissible threshold boom value for each of the one or more locations. The method may also include outputting the generated at least one of the target altitude and the target speed to a display system.

A system for generating and displaying at least one of a target altitude and a target speed to an operator of a vehicle may include a memory storing instructions, and a processor executing the instructions to perform a process. The process may include receiving speed data, altitude data, and flight path data for a flight path of the vehicle, and generating at least one of a target altitude and a target speed for each of one or more locations along the flight path based on the received speed data, altitude data, and flight path data and a permissible threshold boom value for each of the one or more locations. The process may also include outputting the generated at least one of the target altitude and the target speed to a display system.

A non-transitory computer-readable medium may store instructions that, when executed by a processor, cause the processor to perform a method. The method may include receiving speed data, altitude data, and flight path data for a flight path of the vehicle, and generating at least one of a target altitude and a target speed for each of one or more locations along the flight path based on the received speed data, altitude data, and flight path data and a permissible threshold boom value for each of the one or more locations. The method may also include outputting the generated at least one of the target altitude and the target speed to a display system.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system for generating and displaying at least one of a target altitude and a target speed to an operator of a vehicle, according to one or more embodiments.

FIG. 2 depicts a graph of time against amplitude for an exemplary planned flight path, and shows generated target altitudes, according to one or more embodiments.

FIG. 3 depicts a graph of time against speed for an exemplary planned flight path, and shows generated target speeds, according to one or more embodiments.

FIG. 4 depicts a flowchart for generating and outputting a target altitude and/or a target speed based on a permissible boom value, according to one or more embodiments.

FIG. 5 depicts a flowchart for generating and outputting a target altitude and/or a target speed based on a permissible boom value and a buffer altitude and/or a buffer speed, and for determining, if a boom value is not permissible, time points for target altitude(s) and/or target speed(s) for locations before a target waypoint on a flight path, and outputting alerts corresponding to the determined time points, according to one or more embodiments.

FIG. 6 depicts an example display of a planned flight path and one or more generated target altitudes, as viewed by an operator of a vehicle, according to one or more embodiments.

FIG. 7 depicts an example display of the generated target altitude and the generated target speed, as viewed by an operator of a vehicle, according to one or more embodiments.

FIG. 8 depicts an example system that may execute techniques presented herein.

### DETAILED DESCRIPTION OF EMBODIMENTS

In general, the present disclosure is directed to methods and systems for generating and displaying at least one of a target altitude and a target speed to an operator of a vehicle during supersonic flight of the vehicle, and, in addition or alternatively, using the generated target altitude and target speed in updating a flight plan for the vehicle. For instance, a method of the present disclosure may include receiving speed data, altitude data, and flight path data for a flight path of the vehicle, and processing the received speed data, altitude data, and flight path data to generate at least one of a target altitude and a target speed at one or more locations along the flight path. Generation of the at least one target altitude and target speed for each location of the one or more locations may be based on a permissible threshold boom value for each location of the one or more locations. The method may also include outputting the generated at least one of the target altitude and the target speed to a display. In addition or alternatively to outputting the generated target altitude and target speed, the method may also include using the generated target altitude and target speed to update a flight plan of the vehicle.

By virtue of the methods and the related systems disclosed herein, information can be quickly and efficiently generated and displayed to an operator of a vehicle, or used to update a flight plan of a vehicle, to ensure the vehicle does not generate sonic booms that exceed permissible threshold boom values for locations along a flight path.

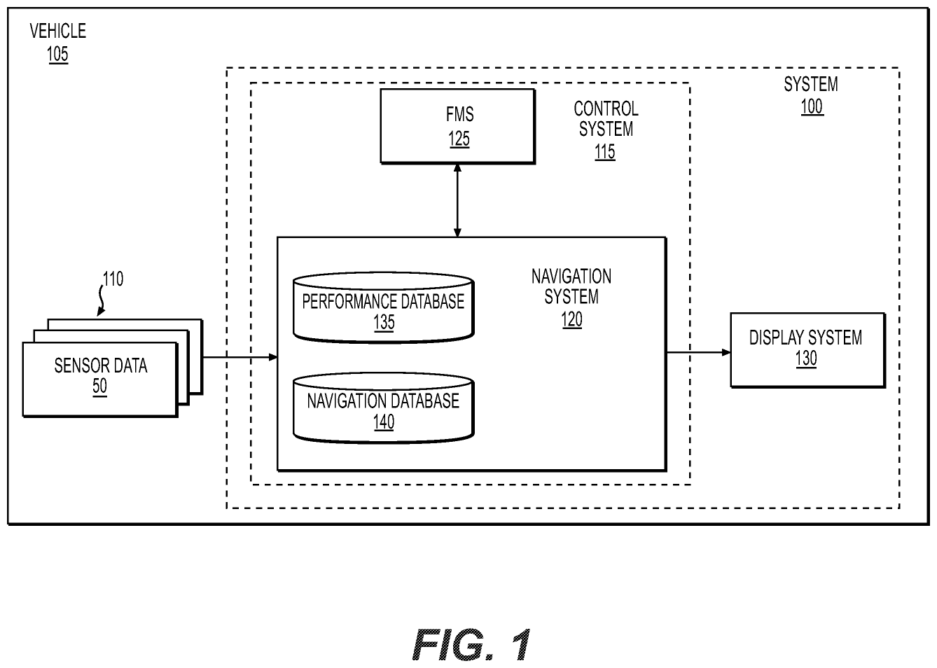

FIG. 1 depicts an exemplary block diagram of a system 100 for generating at least one of a target altitude and a target speed and outputting the generated target altitude and/or target speed to a display of a vehicle, according to one or more embodiments. The system 100 is shown as being installed within a vehicle 105, which may be a supersonic aircraft, although the vehicle 105 is not so limited, and may also be a supersonic drone (e.g., an unmanned aircraft), a rocket, a spacecraft, or any other vehicle capable of traveling at supersonic speed. The vehicle 105 may also be equipped with one or more sensors 110, including at least a speed sensor and an altitude sensor, described in more detail below. The system 100 includes a control system 115, which comprises a navigation system 120 and a flight management system (FMS) 125, and a display system 130 (or, generally, a user interface system). The system 100 may be housed within the vehicle 105, as shown in FIG. 1, and, more specifically, may be installed within a cockpit of the vehicle 105, for example. Portions of the system 100, such as the FMS 125 and/or portions of the navigation system 120, may, however, be located outside of the vehicle 105.

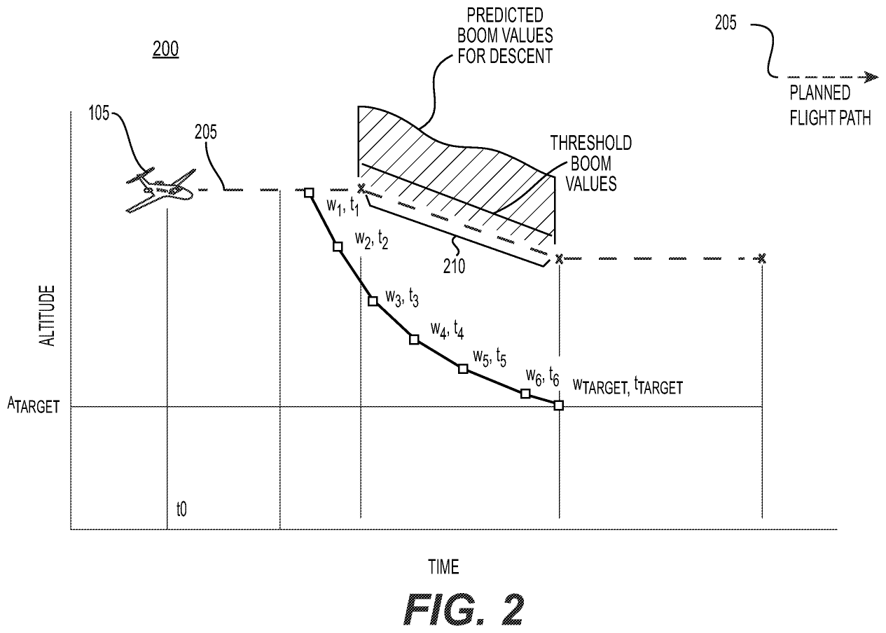

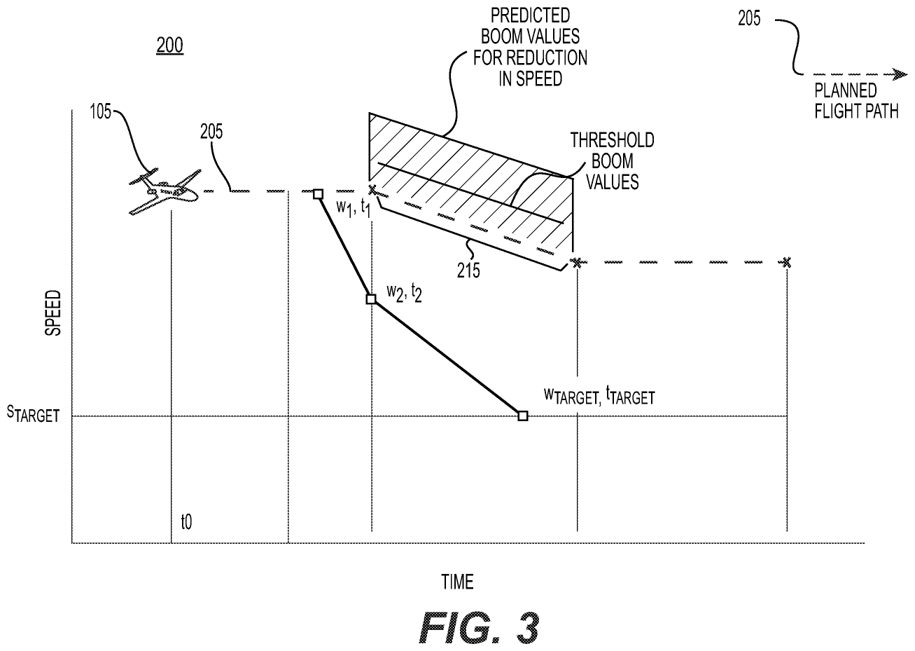

The FMS 125 may store a flight plan 200, including a planned flight path 205 (as shown in FIGS. 2 and 3), of the vehicle 105, and may manage the flight plan 200 of the vehicle 105 based on inputs, such as user or system inputs, such as inputs from the sensors 110. The FMS 125 may continuously perform calculations along the planned flight path 205, as the vehicle 105 proceeds along or near to the planned flight path 205. In performing these calculations, the FMS 125 may account for a required time of arrival (RTA) of the vehicle 105 to a destination, restricted airspace, weather or atmospheric conditions, air traffic from other aircraft, limitations to ensure passenger comfort, etc. And, with respect to some of the data accounted for by the FMS 125, the FMS 125 may continually (e.g., periodically) update the planned flight path 205 based on this data, such as data relating to weather or atmospheric conditions. The FMS 125 may also update the planned flight path 125 based on changes in data, e.g., changes in the weather or atmospheric conditions, during a flight. In addition, the FMS 125 may use performance data of the vehicle, described in more detail below, to determine waypoints and times for transitions, such as deceleration, along the planned flight path 205. As depicted in FIG. 2, for example, the flight plan 200 may include altitudes for the planned flight path 205 between various points (e.g., waypoints, such as waypoints w1 to w6, at times t1 to t6, respectively, shown in FIG. 2). As shown in FIG. 2, the flight plan 200 may indicate that at waypoint w1, the vehicle 105 is to change altitude by climbing or descending (referred to herein as “transition points”). Notably, however, the flight plan 200 may indicate a transition at a different point, other than a named waypoint, such as before or after waypoint w1.

As depicted in FIG. 3, the flight plan 200 may also include speeds for the planned flight path 205 between various waypoints (e.g., waypoints, such as waypoints w1 and w2, at times t1 and t2, respectively, shown in FIG. 3). The flight plan 200 may also indicate that at waypoint w1, the vehicle 105 is to change speed by decelerating (or accelerating) (also referred to herein as “transition points”), and may include transitions from supersonic to subsonic flight, or vice versa. Flight plans may indicate transition points based on various criteria, such as RTA, restricted airspace, air traffic from other aircraft, efficient use of fuel, weather conditions, etc. Furthermore, the flight plan 200 may be updated before and/or during a flight of the vehicle 105, such as by an operator, e.g., a pilot, or based on user or system inputs to the FMS 125.

The navigation system 120 includes a performance database 135 that stores performance data of the vehicle 105, described in more detail below, and a navigation database 140 that stores the flight plan 200. The navigation system 120 may control navigation of the vehicle 105, based at least in part on the flight plan 200 and calculations performed by the FMS 125, to control the vehicle 105 along the flight path 200, including along maneuvers and through transition points. One maneuver may be a descent maneuver, such as an automated descent maneuver that has an automated descent path 210, shown in FIG. 2, or an automated deceleration maneuver that has an automated deceleration path 215, shown in FIG. 3. The automated descent maneuver and the automated deceleration maneuver are just two examples of a plurality of maneuvers that may be programmed into the FMS 125 or the navigation system 120, and stored, for example, in the navigation database 140. The plurality of maneuvers may be designed based on circumstances (e.g., starting altitude, cruising altitude, ending altitude, geographic conditions, weather conditions, etc.) for the route through which the vehicle is to travel, and may further be designed based on specific characteristics of the vehicle 105 (e.g., characteristics of all vehicles of a type similar or same as the vehicle 105, including center of gravity (CG), weight, etc.). The plurality of maneuvers may be included as part of the flight plan 200 (e.g., takeoff, climb, cruise, accelerate, decelerate, descend, landing, etc.). Generally, the plurality of maneuvers may be flight path curves that indicate an altitude and/or a speed, with respect to time, and one or more waypoints of the vehicle 105 through a maneuver. The plurality of maneuvers may be stored in the performance database 135, e.g., with identifiers.

The navigation system 120, in conjunction with the FMS 125, controls actuation systems of the vehicle 105, which may include motors, engines, and/or propellers to generate thrust, lift, and/or directional force for the vehicle 105, and flaps or other control surfaces to augment the thrust, lift, and/or directional force for the vehicle 105, to carry out the plurality of maneuvers of the flight plan 200. The navigation system 120 may collect sensor data 50 from various sensors 110 installed on the vehicle 105, and may also receive navigation and performance-related data from external systems connected to the navigation system 120 via a wired and/or a wireless connection. The received data may be stored in one or more databases of the navigation system 120, such as the performance database 135 and the navigation database 140, depending on the type of data. For example, in a case in which the vehicle 105 is an aircraft, aerodynamic and engine performance models of the aircraft, maximum take-off weight, fuel weight, and distribution models, CG models and CG thresholds, drag models, and other data relating to the particular aircraft may be stored in the performance database 135. The aerodynamic and engine performance models may include a flight envelope for maneuvers of the vehicle 105, and a prediction model, discussed in detail below. The information stored in the performance database 135 may be used to predict performance of the vehicle in a maneuver, such as the automated descent maneuver or the automated deceleration maneuver noted above, and, more specifically, to predict a boom value that will be generated when the vehicle 105 performs such a maneuver.

The navigation database 140 may store information related to navigation or routing of the vehicle 105 in a geographic area. In particular, the navigation database 140 may contain data elements that indicate restrictions on maneuvers, such as supersonic flight restrictions. The supersonic flight restrictions may indicate three-dimensional zones in which supersonic flight is not allowed, or is allowed but in a limited manner. More specifically, the supersonic flight restrictions may include permissible threshold boom values for waypoints along the planned flight path 205, as well as for locations near the waypoints of the planned flight path 205. The permissible threshold boom values indicate, for example, maximum boom values for particular waypoints. The information stored in the navigation database 140 may also include, for example, the waypoints, airports, runways, airways, radio navigation aids, holding patterns, etc.

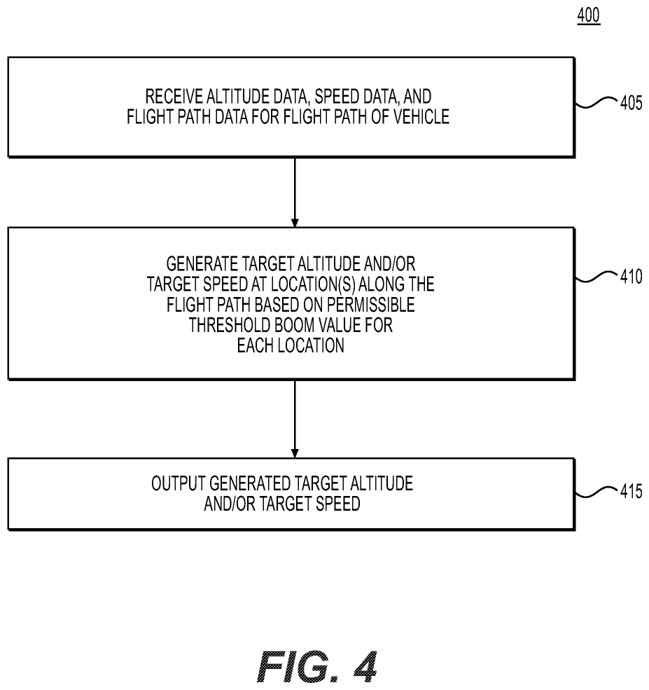

With reference to FIG. 4, in one aspect of the disclosure, the system 100, and, in particular, the control system 115 may perform a process 400 of generating a target altitude and/or a target speed to an operator of the vehicle 105 via a display of the display system 130, and, alternatively or in addition to outputting these values, using the target altitude and/or the target speed to update the flight plan 200 using the control system 115. The process 400 may include receiving altitude data, speed data, and flight path data for a flight path of the vehicle 105 in step 405. Then, in step 410, the process 400 includes processing the received altitude data, speed data, and flight path data to generate at least one of a target altitude A_{Target} and a target speed S_{Target} at one or more locations along the flight path. The target altitude A_{Target} and the target speed S_{Target} are generated based on a permissible threshold boom value for each location of the one or more locations along the flight path. Then, in step 415, the process 400 includes outputting the generated target altitude A_{Target} and/or the target speed S_{Target} to the operator via a display of the display system 130. Alternatively, or in addition, the process 400 may include using the generated target altitude A_{Target} and/or the target speed S_{Target} to update the planned flight path 205 of the vehicle 105.

To obtain the altitude data and speed data, the control system 115 may continually or periodically request and receive the sensor data 50 from the one or more sensors 110, which are connected to other systems of the vehicle 105. For instance, the control system 115 may receive speed data from a speed sensor, and altitude data from an altitude sensor.

To obtain flight path data for a flight path of the vehicle 105, the control system 115 may request a copy of the flight plan 200, or at least a portion thereof, from the FMS 125. The flight path data includes, for example, altitudes and speeds for a plurality of waypoints along the planned flight path 205. In the process 400 described above, the control system 115 may request an altitude and a speed for a particular waypoint, such as a target waypoint w_{Target}, along the planned flight path 205. In addition, the control system 115 may receive updates to the flight plan 200 from the FMS 125 during the flight.

The control system 115 may also monitor progress of the vehicle 105 through the flight plan 200, by extracting position data (e.g., GPS data, heading data, track data, etc.) from the sensor data 50, and comparing the position data to points of the planned flight path 205. For instance, the control system may determine the position data indicates the vehicle 105 is a distance away (or time away) from a next waypoint on the planned flight path 205.

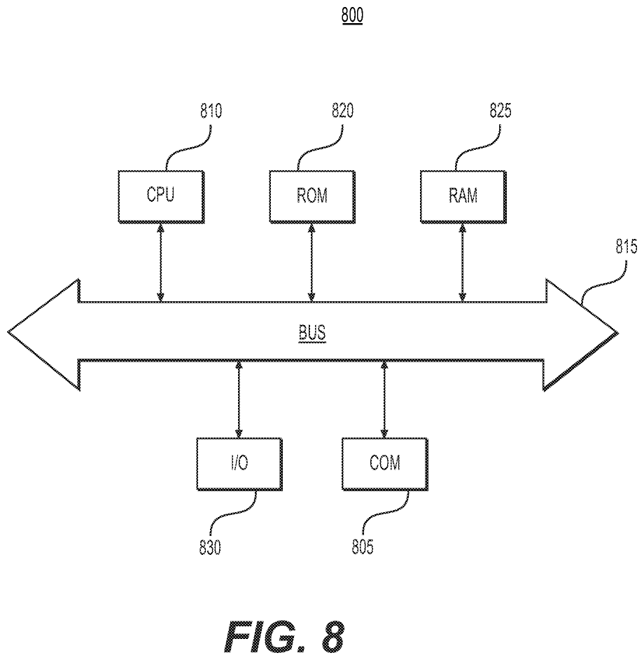

In performing processing of received altitude data, speed data, and flight path data to generate a target altitude A_{Target} and/or a target speed S_{Target}, during the process 400, the control system 115 executes an algorithm, which may be stored in a memory of the control system 115, shown in FIG. 8, and described below. The algorithm may include performance calculations used to determine performance characteristics, such as determining a thrust-to-weight ratio, a drag force, a timing or duration of the flight based on data relating to the vehicle 105 and environmental data, such as air temperature, air density, etc. The algorithm also includes a sonic boom algorithm, which calculates a boom value for a given waypoint along the planned flight path 205 using performance tables for the vehicle 105. The performance tables are stored in the performance database 135. The sonic boom algorithm uses the received speed data and altitude data, the flight path data, performance tables for the vehicle 105, stored in the performance database 135, and performance measurements of the vehicle 105, in calculating the boom value for the waypoint.

The control system 115 then compares the calculated boom value to a permissible threshold boom value for the location corresponding to the waypoint. If the calculated boom value is less than or equal to the permissible threshold boom value, for example, the control system 115 proceeds with setting a target altitude A_{Target} and a target speed S_{Target} for the waypoint. That is, the calculated boom value that is determined to be less than or equal to the permissible threshold boom value is used to calculate a target altitude A_{Target} and a target speed S_{Target}. The target altitude and the target speed are specific to the waypoint for which the boom value is calculated. The control system 115 may execute the algorithm for more than one waypoint along the planned flight path 205, to ensure the vehicle does not generate a sonic boom that exceeds permissible threshold boom values at any waypoint along the planned flight path 205.

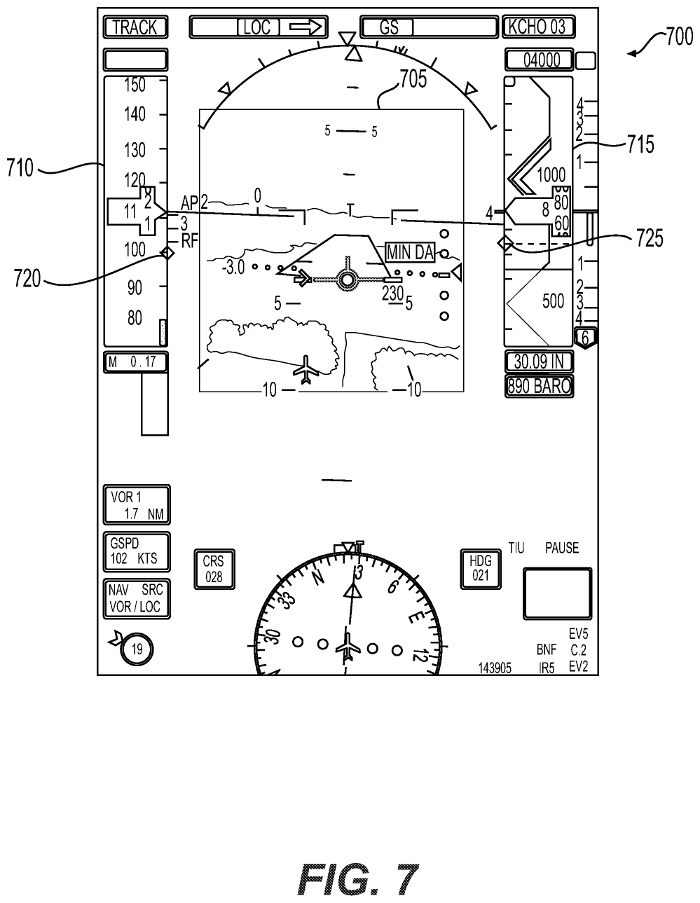

To output the generated target altitude A_{Target} and/or the target speed S_{Target}, the control system 115 electronically transmits the target altitude A_{Target} and/or the target speed S_{Target} to the display system 125, which causes a display, shown in FIG. 7, for example, to display these values to the operator of the vehicle 105. Additionally or alternatively, the control system 115 may also use these values to adjust or to update the flight plan 200, and, more specifically, to update the planned flight path 205 by replacing an altitude and/or a speed for the target waypoint w_{Target} with the generated target altitude A_{Target} and the target speed S_{Target}, respectively, within the planned flight path 205. By virtue of this replacement, the vehicle 105 proceeds along the planned flight path 205 through the target waypoint w_{Target} at an altitude and a speed for which a boom value is permissible.

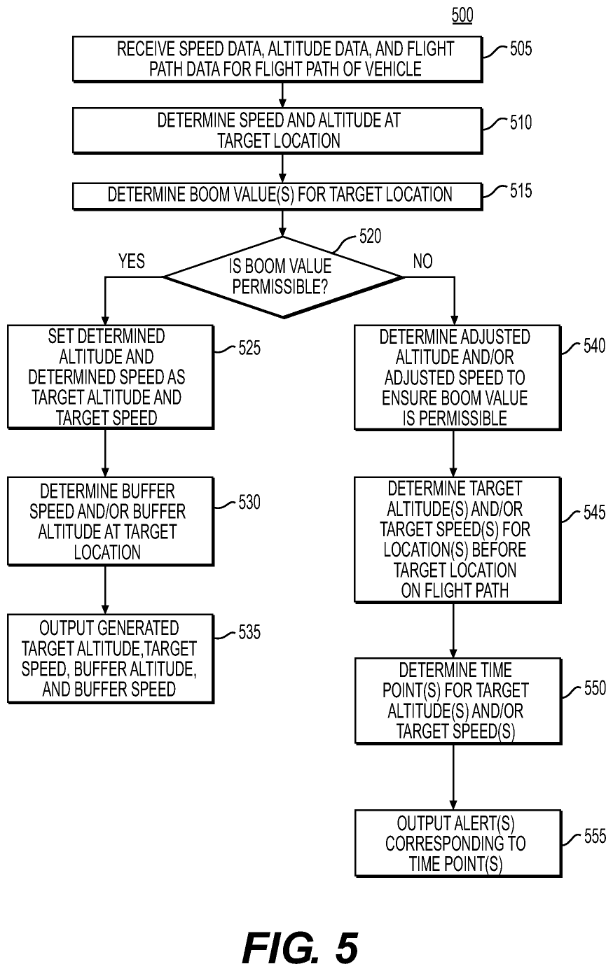

With reference to FIG. 5, in another aspect of the disclosure, the system 100, and, in particular, the control system 115 may perform a process 500 of outputting alerts relating to adjusted target altitudes and/or adjusted target speeds, in addition to outputting a target altitude A_{Target} and/or a target speed S_{Target}, to an operator of the vehicle 105, based on a determination of whether the boom value is permissible. The process 500 may include the control system 115 receiving altitude data, speed data, and flight path data for a planned flight path 205 of the vehicle 105 in step 505. Then, the control system 115 determines an altitude and a speed at a target waypoint w_{Target} based on the flight path data in step 510. In step 515, the control system 115 determines one or more boom values for the target waypoint w_{Target} based on the altitude and the speed determined in step 510. A single boom value may be determined corresponding to the target waypoint w_{Target} , or more than one boom value may be determined for locations along a boom carpet that will be generated by the vehicle 105. In step 520, the control system 115 determines whether the determined one or more boom values are permissible by, for example, comparing the determined boom values to permissible threshold boom values for the corresponding locations. Each of the determined boom values may be permissible if it is less than or equal to the corresponding permissible threshold boom value.

If the control system 115 determines that the boom value is permissible (YES in step 520), in step 525, the control system 115 sets the determined altitude as the target altitude A_{Target}, and the determined speed as the target speed S_{Target}. Then, in step 530, the control system 115 determines a buffer altitude A_{Buffer} and/or a buffer speed S_{Buffer} at the target waypoint w_{Target}. The buffer altitude A_{Buffer}, for example, may be a change in altitude from the determined altitude for the target waypoint w_{Target}, for which a boom value would remain permissible, that is, less than or equal to the corresponding permissible threshold boom value. Similarly, the buffer speed S_{Buffer} may be a change in speed from the determined speed for the target waypoint w_{Target}, for which a boom value would remain permissible, that is, less than or equal to the corresponding permissible threshold boom value. Then, in step 535, the control system 115 outputs the target altitude A_{Target}, the buffer altitude A_{Buffer}, the target speed S_{Target}, and the buffer speed S_{Buffer} to the operator of the vehicle 105 via a display of the display system 130, and, alternatively or in addition, uses the target altitude A_{Target}, the buffer altitude A_{Buffer}, the target speed S_{Target}, and the buffer speed S_{Buffer} to update the flight plan 200 using the control system 115.

If, on the other hand, the control system 115 determines that the boom value is not permissible (NO in step 520), in step 540, the control system 115 determines an adjusted altitude A_{Adjusted} and/or an adjusted speed S_{Adjusted} at the target waypoint w_{Target} for which a boom value would be permissible, that is, for which the boom value will be less than or equal to the corresponding permissible threshold boom value. In step 545, the control system 115 then sets the adjusted altitude A_{Adjusted} as a target altitude A_{Target_i} and the adjusted speed S_{Adjusted} as a target speed S_{Target} for one or more locations wᵢ before the target waypoint w_{Target}, that is, one or more intermediate locations, on the planned flight path 205. Then, in step 550, the control system 115 determines time points for the target altitude A_{Target_i} and the target speed S_{Target_i} for the one or more intermediate locations wᵢ before the target waypoint w_{Target}. And, in step 555, the control system 115 outputs the target altitude A_{Target_i}, the target speed S_{Target_i}, and the alerts to the operator via the display of the display system 130, the alerts corresponding to the time points and including the corresponding target altitude A_{Target_i} and the target speed S_{Target_i}. Alternatively, or in addition, the process 500 may include using the generated target altitude A_{Target_i} and the generated target speed S_{Target_i} o update the planned flight path 205 of the vehicle 105.

As with the process 400, the control system 115 may continually or periodically request and receive the sensor data 50 from the one or more sensors 110, which are connected to other systems of the vehicle 105, to obtain at least the altitude data and speed data. For instance, the control system 115 may receive speed data from a speed sensor, and altitude data from an altitude sensor. Also, the control system 115 may request a copy of the flight plan 200, or at least a portion thereof, from the FMS 125, to obtain flight path data for a flight path of the vehicle 105. The flight path data includes, for example, altitudes and speeds for a plurality of waypoints along the planned flight path 205. In the process 500 described above, the control system 115 may request an altitude and a speed for one or more particular waypoints, such as a target waypoint w_{Target}, along the planned flight path 205, to determine the altitude and the speed at the target waypoint w_{Target}. In addition, the control system 115 may receive updates to the flight plan 200 from the FMS 125 during the flight.

The control system 115 may also monitor progress of the vehicle 105 through the flight plan 200, by extracting position data (e.g., GPS data, heading data, track data, etc.) from the sensor data 50, and comparing the position data to points of the planned flight path 205. For instance, the control system 115 may determine that the position data indicates the vehicle 105 is a distance away (or time away) from a next waypoint on the planned flight path 205.

In determining one or more boom values for the target waypoint w_{Target}, the control system 115 executes an algorithm, which may be stored in the memory of the control system 115, shown in FIG. 8, and described below. The algorithm may include performance calculations used to determine performance characteristics, such as determining a thrust-to-weight ratio, a drag force, a timing or duration of the flight based on data relating to the vehicle 105 and environmental data, such as air temperature, air density, etc. The algorithm also includes a sonic boom algorithm, which calculates a boom value for a given waypoint along the planned flight path 205 using the performance tables for the vehicle 105. As noted above, the performance tables are stored in the performance database 135. The sonic boom algorithm uses the determined altitude and speed for the target waypoint w_{Target}, the performance tables for the vehicle 105, stored in the performance database 135, and performance measurements of the vehicle 105, in calculating the boom value for the target waypoint w_{Target}. The control system 115 may calculate a plurality of boom values for the target waypoint w_{Target}, corresponding to locations along the boom carpet that will be generated by the vehicle 105. That is, for each waypoint w along the planned flight path, more than one boom value may be calculated to ensure the vehicle 105 does not create a sonic boom that exceeds permissible threshold boom values at any of the locations along the boom carpet.

The control system 115 then compares the calculated one or more boom values to corresponding permissible threshold boom values for the location corresponding to the target waypoint w_{Target}. If each calculated boom value is less than or equal to the corresponding permissible threshold boom value, for example, the control system 115 proceeds with setting the determined altitude as a target altitude A_{Target} and the determined speed as a target speed S_{Target} for the target waypoint w_{Target}. The control system 115 then determines the buffer altitude A_{Buffer} and/or the buffer speed S_{Buffer} at the target waypoint w_{Target}. The control system 115 may execute an algorithm to determine the buffer altitude A_{Buffer} and the buffer speed S_{Buffer}, which may use a difference between a calculated boom value and a corresponding permissible threshold boom value, as well as the set target altitude A_{Target} and the set target speed S_{Target}, for example. And, as noted above, the buffer altitude A_{Buffer} may represent a change in altitude from the determined altitude for the target waypoint w_{Target}, for which a boom value would remain permissible, that is, less than or equal to the corresponding permissible threshold boom value, and the buffer speed S_{Buffer} may represent a change in speed from the determined speed for the target waypoint w_{Target}, for which a boom value would remain permissible, that is, less than or equal to the corresponding permissible threshold boom value.

If the control system 115 determines that the boom value is not permissible, the control system 115 determines the adjusted altitude A_{Adjusted} and/or the adjusted speed S_{Adjusted} at the target location w_{Target} for which a boom value would be permissible. In particular, the control system 115 uses a difference between a calculated boom value and a corresponding permissible threshold boom value, as well as the determined altitude and the determined speed to calculate the adjusted altitude A_{Adjusted} and the adjusted speed S_{Adjusted}, respectively. The control system 115 then sets the adjusted altitude A_{Adjusted} as the target altitude A_{Target}, and the adjusted speed S_{Adjusted} as the target speed S_{Target}, for the target waypoint w_{Target}. The control system 115 may perform the calculations and set target altitudes and target speeds for a plurality of waypoints along the planned flight path 205. The control system 115 also determines time points for each set target altitude A_{Target_i} and each set target speed S_{Target_i}. More specifically, the control system 115 uses a current altitude, a current speed, and set altitudes and speeds for waypoints between a current position of the vehicle and the target waypoint w_{Target} to calculate a time point for the target waypoint w_{Target}.

To output the generated target altitudes A_{Target_i} and/or the target speeds S_{Target_i}, the control system 115 electronically transmits the target altitudes A_{Target_i} and/or the target speeds S_{Target_i} to the display system 130, which causes a display, shown in FIG. 7, for example, to display these values to the operator of the vehicle 105. Additionally or alternatively, the control system 115 may also use these values to adjust or to update the flight plan 200, and, more specifically, to update the planned flight path 205 by replacing an altitude and/or a speed for a target waypoint w_{Target_i} with the generated target altitude A_{Target_i} and the target speed S_{Target_i} , respectively, for that target waypoint w_{Target_i} within the planned flight path 205. By virtue of this replacement, the vehicle 105 can automatically proceed, by virtue of the control system 115, along the planned flight path 205 through the target waypoint w_{Target_i} at an altitude and a speed for which a boom value is permissible.

The step 515 of determining one or more boom values for the target waypoint w_{Target} may also include obtaining environment data for the target waypoint w_{Target}. Environment data may include weather data, such as air temperature, wind speed, and wind direction, for example. The environment data may be obtained from other vehicles that have passed through the target waypoint w_{Target} ahead of the vehicle, within a predetermined period of time. For example, if another aircraft has passed through the target waypoint w_{Target} within 30 minutes of a time that the vehicle 105 is set to pass through the target waypoint w_{Target}, the environment data from the other aircraft may be obtained via the FMS 125. The one or more boom values are then determined based not only on the speed and altitude for the target waypoint w_{Target}, but also on the obtained environment data.

To determine a boom value using environment data, the control system 115 executes an algorithm that may be stored in the memory of the control system 115, shown in FIG. 8. The algorithm may include performance calculations, as well as the sonic boom algorithm described above. In this embodiment, the sonic boom algorithm calculates the boom value for a given waypoint using the performance tables, performance measurements of the vehicle, and the determined altitude and speed for a target waypoint w_{Target}. The control system 115 may calculate a plurality of boom values for the target waypoint w_{Target_i}, corresponding to locations along the boom carpet that will be generated by the vehicle 105. That is, for each waypoint w along the planned flight path, more than one boom value may be calculated to ensure the vehicle 105 does not create a sonic boom that exceeds permissible threshold boom values at any of the locations along the boom carpet.

The processes 400 and 500 described above may be performed continually, periodically, or upon receiving a request from an operator of the vehicle 105, for example. And the processes 400 and 500 may be performed more than once for the same target waypoint w_{Target}, or target waypoints, or for target waypoints further along the planned flight path 205, as the vehicle 105 progresses along the planned flight path 205. In addition, the processes 400 and 500 may generate only one of an altitude or a speed, or both of an altitude and a speed for a given target waypoint w_{Target}. The processes 400 and 500 may also be performed based on a distance remaining to arrival at the destination, for example, 50 miles from an airport, to confirm that transitions for a descent, approach, and landing do not generate boom values that exceed permissible threshold boom values.

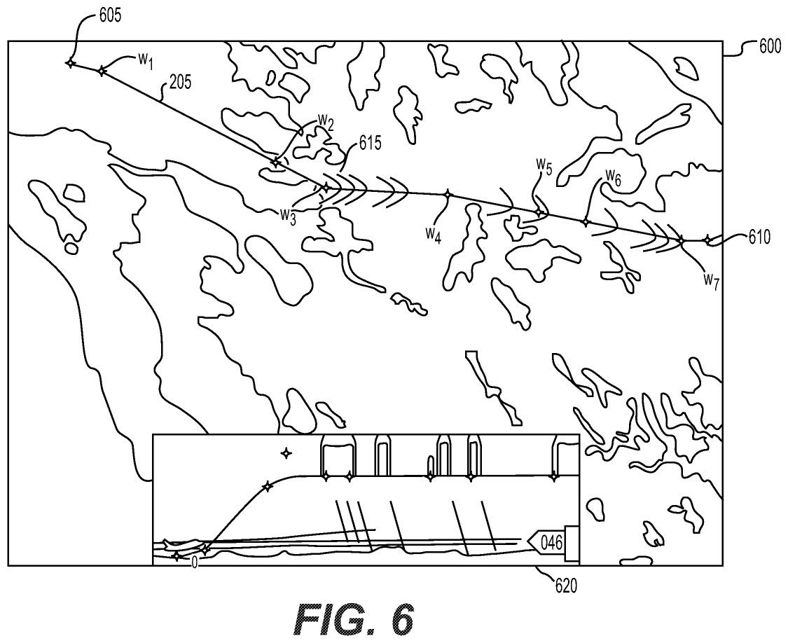

FIG. 6 depicts an example display of the planned flight path 205, as viewed by an operator of the vehicle 105, according to one or more embodiments. In particular, FIG. 6 shows a map 600 of the planned flight path 205, including a starting location 605 and an end location 610, with a number of waypoints w (w₁ to w₇) therebetween. Carets 615 (or chevrons 615) along the planned flight path 205 indicate locations at which the vehicle 105 is to decelerate, according to the flight plan 200. As the vehicle 105 progresses along the planned flight path 205, the locations of the carets may change. FIG. 6 also includes an inset altitude graphic 620 at a bottom portion of the example display, as viewed by the operator of the vehicle 105. The altitude graphic 620 shows altitudes along the planned flight path 205, as well as boom values determined for a number of the waypoints w along the planned flight path 205. The altitude graphic 620 may also include permissible threshold boom values for the waypoints w along the planned flight path 205, so that the operator of the vehicle 105 can confirm whether boom values for the waypoints w are permissible.

FIG. 7 depicts another example display of the generated target altitude A_{Target} and the generated target speed S_{Target}, as viewed by an operator of a vehicle, according to one or more embodiments. More specifically, FIG. 7 shows a display 700, including a projected forward view 705 of the flight path of the vehicle 105, and an airspeed tape 710 and an altitude tape 715 along the sides of the projected forward view 705. The airspeed tape 710 shows a current speed of the vehicle 105, based on inputs from a speed sensor, and the altitude tape 715 shows a current altitude of the vehicle 105, based on inputs from an altitude sensor of the vehicle 105. The airspeed tape 710 also includes a target speed indicator 720, which indicates the target speed S_{Target}, as determined in the process 400 or the process 500, described above. The altitude tape 715 includes a target altitude indicator 725, which indicates the target altitude A_{Target}, as determined in the process 400 or the process 500, described above. The display 700 may also include an indicator of a time remaining for the vehicle 105 to adjust the speed to the target speed S_{Target}, or for the vehicle 105 to adjust the altitude to the target altitude A_{Target}. Alternatively or in addition, the display 700 may include an indicator of a lateral distance between a current position of the vehicle and the target waypoint w_{Target}, at which the target speed and/or the target altitude should be reached in order to reduce or avoid a sonic boom.

FIG. 8 depicts an example system 800, such as the control system 115, that may execute techniques presented herein. FIG. 8 is a simplified functional block diagram of a computer that may be configured to execute techniques described herein, according to exemplary embodiments of the present disclosure. Specifically, the computer (or “platform” as it may not be a single physical computer infrastructure) may include a data communication interface 805 for packet data communication. The platform may also include a central processing unit (“CPU”) 810, in the form of one or more processors, for executing program instructions. The platform may include an internal communication bus 815, and the platform may also include a program storage and/or a data storage for various data files to be processed and/or communicated by the platform, such as a read only memory (ROM) 820 and a random access memory (RAM) 825, although the system 800 may receive programming and data via network communications. The system 800 also may include input and output (I/O) ports 830 to connect with input and output devices, such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of generating and displaying at least one of a target altitude and a target speed to an operator of a vehicle, the method comprising:
receiving speed data, altitude data, and flight path data for a flight path of the vehicle;
generating at least one of a target altitude and a target speed for each of one or more locations along the flight path based on the received speed data, altitude data, and flight path data and a permissible threshold boom value for each of the one or more locations; and
outputting the generated at least one of the target altitude and the target speed to a display system.

2. The method of claim 1, further comprising at least one of:
generating, on a display of the display system, an indicator for the target altitude alongside an altitude graphic showing a current altitude of the vehicle; and
generating, on the display of the display system, an indicator for the target speed alongside a speed graphic showing a current speed of the vehicle.

3. The method of claim 1, further comprising:
generating, on a display of the display system, the at least one of the target altitude and the target speed as an indicator along a graphical representation of the flight path.

4. The method of claim 1, wherein the generating the at least one of the target altitude and the target speed for each of the one or more locations along the flight path includes:
determining a speed and an altitude of the vehicle at a target waypoint along the flight path;
determining a boom value for the target waypoint based on the speed and the altitude;
determining whether the boom value is permissible based on the permissible threshold boom value;
in response to determining the boom value is permissible, determining at least one of a buffer speed and a buffer altitude for the target waypoint; and
determining the at least one of the target altitude and the target speed based on the at least one of the buffer speed and the buffer altitude.

5. The method of claim 4, wherein the determining the boom value for the target waypoint is further based on environment data for the target waypoint.

6. The method of claim 4, wherein the generating the at least one of the target altitude and the target speed for each of the one or more locations along the flight path further includes:
in response to determining that the boom value is not permissible, determining at least one of an adjusted speed and an adjusted altitude to ensure the boom value for the target waypoint is permissible;
determining, for each of one or more intermediate locations before the target waypoint along the flight path, at least one of an intermediate speed and an intermediate altitude to ensure boom value for the intermediate location is permissible and to ensure the vehicle approaches the target waypoint at the at least one of the adjusted speed and the adjusted altitude;
determining a time point for the at least one of the intermediate speed and the intermediate altitude; and
outputting one or more alerts to the display system, the one or more alerts corresponding to the time point.

7. The method of claim 6, wherein the generating the at least one of the target altitude and the target speed for each of the one or more locations along the flight path further includes:
receiving environment data for the target waypoint from one or more vehicles ahead of the vehicle along the flight path; and
determining the boom value based on the speed, the altitude, and the environment data.

8. A system for generating and displaying at least one of a target altitude and a target speed to an operator of a vehicle, the system comprising:
a memory storing instructions; and
a processor executing the instructions to perform a process including:
receiving speed data, altitude data, and flight path data for a flight path of the vehicle;
generating at least one of a target altitude and a target speed for each of one or more locations along the flight path based on the received speed data, altitude data, and flight path data and a permissible threshold boom value for each of the one or more locations; and
outputting the generated at least one of the target altitude and the target speed to a display system.

9. The system of claim 8, wherein the process further includes at least one of:
generating, on a display of the display system, an indicator for the target altitude alongside an altitude graphic showing a current altitude of the vehicle; and
generating, on the display of the display system, an indicator for the target speed alongside a speed graphic, showing a current speed of the vehicle.

10. The system of claim 8, wherein the process further includes:
generating, on a display of the display system, the at least one of the target altitude and the target speed as an indicator along a graphical representation of the flight path.

11. The system of claim 8, wherein the generating the at least one of the target altitude and the target speed for each of at the one or more locations along the flight path includes:
determining a speed and an altitude of the vehicle at a target waypoint along the flight path;
determining a boom value for the target waypoint based on the speed and the altitude;
determining whether the boom value is permissible based on the permissible threshold boom value;
in response to determining the boom value is permissible, determining at least one of a buffer speed and a buffer altitude for the target waypoint; and
determining the at least one of the target altitude and the target speed based on the at least one of the buffer speed and the altitude.

12. The system of claim 11, wherein the determining the boom value for the target waypoint is further based on environment data for the target waypoint.

13. The system of claim 12, wherein the generating the at least one of the target altitude and the target speed for each of the one or more locations along the flight path further includes:
in response to determining that the boom value is not permissible, determining at least one of an adjusted speed and an adjusted altitude to ensure the boom value for the target waypoint is permissible;
determining, for each of one or more intermediate locations before the target waypoint along the flight path, at least one of an intermediate speed and an intermediate altitude to ensure boom value for the intermediate location is permissible and to ensure the vehicle approaches the target waypoint at the at least one of the adjusted speed and the adjusted altitude;
determining a time point for the at least one of the intermediate speed and the intermediate altitude; and
outputting one or more alerts to the display system, the one or more alerts corresponding to the time point.

14. The system of claim 13, wherein the generating the at least one of the target altitude and the target speed for each of the one or more locations along the flight path further includes:
receiving environment data for the target waypoint from one or more vehicles ahead of the vehicle along the flight path; and
determining the boom value based on the speed, the altitude, and the environment.

15. A non-transitory computer-readable medium storing instructions that, when executed by a processor, cause the processor to perform a method of generating and displaying at least one of a target altitude and a target speed to an operator of a vehicle, the method comprising:
receiving speed data, altitude data, and flight path data for a flight path of the vehicle;
generating at least one of a target altitude and a target speed for each of one or more locations along the flight path based on the received speed data, altitude data, and flight path data and a permissible threshold boom value for each of the one or more locations; and
outputting the generated at least one of the target altitude and the target speed to a display system.

16. The non-transitory computer-readable medium of claim 15, wherein the method further comprises at least one of:
generating, on a display of the display system, an indicator for the target altitude alongside an altitude graphic, showing a current altitude of the vehicle; and
generating, on the display of the display system, an indicator for the target speed alongside a speed graphic, showing a current speed of the vehicle.

17. The non-transitory computer-readable medium of claim 15, wherein the method further comprises:
generating, on a display of the display system, the at least one of the target altitude and the target speed as an indicator along a graphical representation of the flight path.

18. The non-transitory computer-readable medium of claim 15, wherein the generating the at least one of the target altitude and the target speed for each of the one or more locations along the flight path includes:
determining a speed and an altitude at a target waypoint along the flight path;
determining a boom value for the target waypoint based on the speed and the altitude;
determining whether the boom value is permissible based on the permissible threshold boom value;
in response to determining the boom value is permissible, determining at least one of a buffer speed and a buffer altitude for the target waypoint; and
determining the at least one of the target altitude and the target speed based on the at least one of the buffer speed and the buffer altitude.

19. The non-transitory computer-readable medium of claim 18, wherein the determining the boom value for the target waypoint is further based on environment data for the target waypoint.

20. The non-transitory computer-readable medium of claim 19, wherein the generating the at least one of the target altitude and the target speed for each of the one or more locations along the flight path further includes:
in response to determining that the boom value is not permissible, determining at least one of an adjusted speed and an adjusted altitude to ensure the boom value for the target waypoint is permissible;
determining, for each of one or more intermediate locations before the target waypoint along the flight path, at least one of an intermediate speed and an intermediate altitude to ensure boom values for the intermediate location is permissible and to ensure the vehicle approaches the target waypoint at the at least one of the adjusted speed and the adjusted altitude;
determining a time point for the at least one of the intermediate speed and the intermediate altitude; and
outputting one or more alerts to the display system, the one or more alerts corresponding to the time point.
